(19) United States
(12) Patent Application Publication
(10) Pub. No.: US 2005/0289458 A1
(43) Pub. Date: Dec. 29, 2005

(54) Enhancing browsing in electronic device

(75) Inventor: Jaakko Matias Kylmanen, Oulu (FI)

Correspondence Address: Hollingsworth & Funk, LLC, Suite 125, 8009 34th Avenue South, Minneapolis, MN, 55425, US

(73) Assignee: Nokia Corporation

(21) Appl. No.: 11/146,756

(22) Filed: Jun. 7, 2005

(30) Foreign Application Priority Data
Jun. 28, 2004 (FI) 20045245

(51) Int. Cl. G06F 17/24

(52) U.S. Cl. 715/513; 715/526

(57) ABSTRACT

The invention relates to enhancing browsing in an electronic device. The electronic device comprises a display; a communication unit and a processor for browsing Internet, and a user interface for receiving a command from at least two different commands to load a page from Internet into the display. The processor is configured to display an animated icon on the display while loading the page and to select the animation on the basis of which the command was received.

### FIELD

The invention relates to enhancing browsing in electronic devices

### BACKGROUND

In the past, Internet browsing was performed exclusively using desktop computers. Recently, many different types of electronic devices have been equipped with communication abilities and suitable hardware and software with which Internet browsing is possible. For example, portable personal digital assistants (PDAs) and mobile phones can be used for browsing the Internet. The devices used to browse the Internet may have different user interfaces and capabilities. The size of displays and memory resources of different devices may vary to a great extent.

Programs, such as web browsers, used to browse the Internet are designed to be user-friendly. The browsers may provide the user with different information regarding the actions taken by the user. For example, the browser may display an animated icon on the display when a page is been loaded from the Internet.

In prior art, the same animated icon is displayed every time a page is loaded from the Internet. For example, the user does not see from the icon whether he/she has selected a new link to go “forward” in the Internet, or whether a “back” button has been selected and the browser is currently loading a previous web page. Desktop computers, which are usually equipped with large memory, have a cache memory in which a copy of recently visited pages may be stored. When the user selects the “Back” button, a browsing application may load the desired page from a cache memory and display it without delay. However, many portable devices used in browsing the Internet do not have a cache memory. In such devices, the browsing application must always load the desired page from the Internet even when the user has selected the “Back” button. Such reloading may take several seconds.

### BRIEF DESCRIPTION OF THE INVENTION

An object of the invention is to provide a solution for enhancing browsing. According to an aspect of the invention, there is provided a method of enhancing browsing in an electronic device, wherein a page may be loaded into the display of the device in response to at least two different commands, the method comprising: receiving a command from at least two different commands to load a page into the display of the electronic device; displaying an animated icon on the display while loading the page; selecting the animated on the basis of which the command was received.

According to another aspect of the invention, there is provided an electronic device, comprising: a display; means for browsing the Internet; means for receiving a command from at least two different commands to load a page from the Internet into the display; means for displaying an animated icon on the display while loading the page; and means for selecting the animation on the basis of which the command was received.

The invention provides several advantages. A user can more easily visualize different actions while browsing the Internet. In an embodiment of the invention, an animation with movement to a given direction is selected for the pages that have been displayed before in the same browsing session (i.e. the user has pressed the “Back” button) and an animation with movement to the opposite direction is selected for pages that are displayed for the first time in the same browsing session. Thus, the user may easily differentiate forward-backward actions while browsing. This is especially useful when using portable devices having limited memory capabilities which do not save recently visited pages in a cache memory.

### LIST OF DRAWINGS

In the following, the invention will be described in greater detail with reference to the embodiments and the accompanying drawings, in which

FIG. 1 shows an example of an electronic device of an embodiment;

FIG. 2 is a flowchart of an embodiment of the invention; and

FIGS. 3A and 3B illustrate examples of the display of the device.

### DESCRIPTION OF EMBODIMENTS

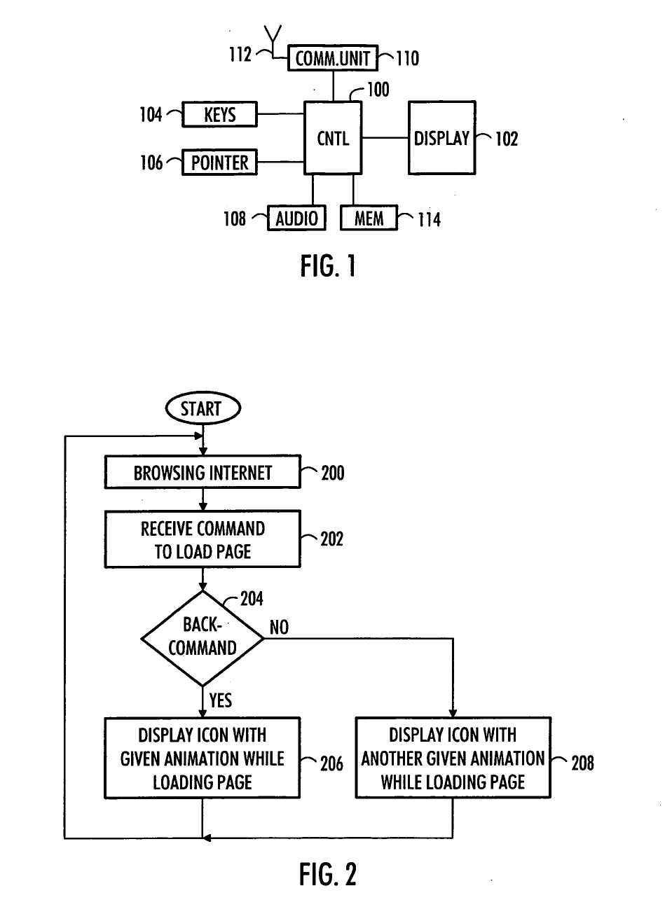

With reference to FIG. 1, examine an example of an electronic device to which embodiments of the invention can be applied. The electronic device comprises a controlling processor 100, typically implemented with a microprocessor, a signal processor or separate components and associated software. The device further comprises a display 102. The display is typically configured to display graphics and text. The device may comprise a keyboard 104. The keys are connected to the processor 100. In an embodiment, the keyboard is realized using a touch sensitive display 102. In such a case there may not be a separate keyboard. The device may also comprise a pointer device 106, with which commands may be given to the device. The pointer device may be a mouse, a touch pad or any other corresponding input device, as one skilled in the art is aware.

The device may also comprise an audio interface 108, which typically comprises a microphone and a loudspeaker, and a communication unit 110 implementing the functions of terminal equipment including speech and channel coders, modulators and RF parts. In some embodiments the device may also comprise an antenna 112. The device may also comprise a memory 114 for storing for example telephone numbers, calendar data and other user-specific data.

The communication unit 110 may also be realized with a Wireless Local Area Network (WLAN) transceiver or a short-range communication transceiver implemented with a Bluetooth chip, for example.

The communication unit 110 may also be a network adapter, with which the device may be connected to a network.

The electronic device may be a personal computer, a mobile telephone or another device including telecommunication means, such as a portable computer, a handheld computer or a smart telephone. The electronic device may be a PDA (Personal Digital Assistant) device including the necessary telecommunication means for establishing a network connection, or a PDA device that can be coupled to a mobile telephone, for instance, for a network connection.

The flowchart of FIG. 2 illustrates an embodiment of the invention. In step 200, the user of a device has started a browsing session and is browsing the Internet. The device is displaying a page on the display 102 of the device.

In step 202, the device receives a command to load a page. The command may be received when the user of the device has clicked a link on the current page with a pointer device 106. The user may have written an address by using the keyboard 104 or the user may have selected a Back-command to view a page that has been viewed previously during the same browsing session.

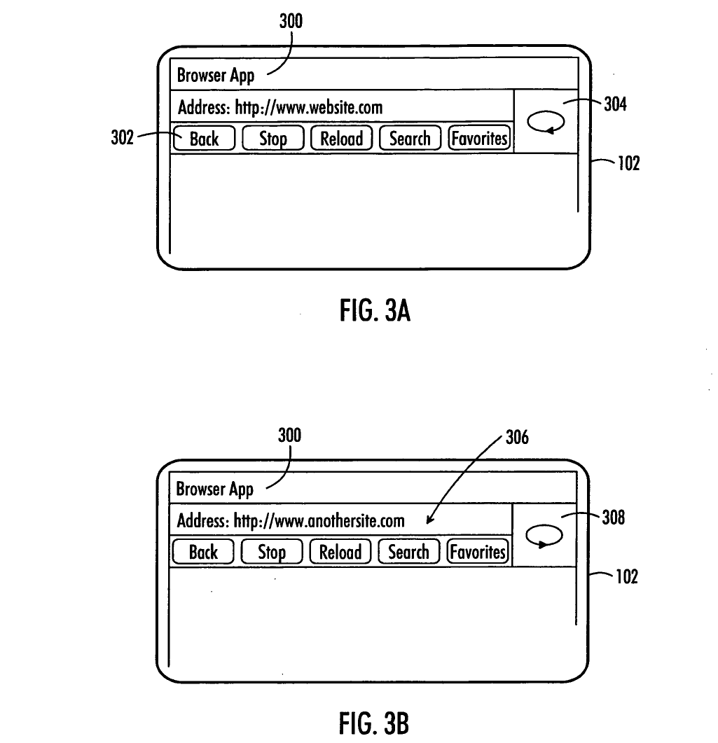

In step 204, the processor 100 checks whether the user selected the Back-command. If this is the case, the processor 100 displays in step 206 an animation with movement to a given direction on the display. The animation may be displayed in a predefined place of the display. FIG. 3A illustrates this step. The display 102 of the device shows a browsing application 300. The user has selected the Back-button 302. The device is configured to load the previous page to the display. While the page is being loaded, an animated icon 304 is shown on the display. In an embodiment the icon may rotate counter clockwise or from right to left.

If the user selected another command to load a page, the processor 100 displays in step 208 an animation with movement to an opposite direction on the display. The animation may be displayed in a predefined place of the display. FIG. 3B illustrates this step. The display 102 of the device shows a browsing application 300. The user has typed a new address in the address field 306 with the keyboard 104. The device is configured to load a new page to the display from the Internet. While the page is being loaded, an animated icon 308 is shown on the display. In an embodiment the icon may rotate clockwise or from left to right.

The process continues from step 200.

In an embodiment, a different animation or animated icon may be displayed during the loading of the pages that have been displayed before in the same browsing session and a different animation or animated icon during the loading of pages that are displayed for the first time in the same browsing session.

In an embodiment, an animation with movement to a given direction may be displayed during the loading of the pages that have been displayed before in the same browsing session or when Back-commend has been selected. Otherwise an animation with movement to the opposite direction is selected.

In an embodiment, the invention is realized with the aid of a computer program product encoding a computer program of instructions for executing a computer process for enhancing browsing in an electronic device, the process comprising: receiving a command from at least two possible commands to load a page into the display of the electronic device, displaying an animated icon on the display while loading the page, and selecting the animation on the basis of which command was received.

In an embodiment, the invention is realized with the aid of a computer program distribution medium readable by a computer and encoding a computer program of instructions for executing a computer process for enhancing browsing in an electronic device, the process comprising: receiving a command from at least two possible commands to load a page into the display of the electronic device, displaying an animated icon on the display while loading the page and selecting the animation on the basis of the command. The distribution medium may comprise a computer readable medium, a program storage medium, a record medium, a computer readable memory, a computer readable software distribution package, a computer readable signal, a computer readable telecommunications signal, and a computer readable compressed software package, for example.

Even though the invention is described above with reference to an example according to the accompanying drawings, it is clear that the invention is not restricted thereto but it can be modified in several ways within the scope of the appended claims.

1. A method of enhancing browsing in an electronic device, wherein a page may be loaded into the display of the device in response to at least two different commands, the method comprising:
receiving a command from at least two different commands to load a page into the display of the electronic device;
displaying an animated icon on the display while loading the page;
selecting the animation on the basis of which the command was received.

2. The method of claim 1, further comprising:
selecting a given animation if the received command is to load a page that has been displayed before in the same browsing session and selecting a different animation if command is to load a page that is displayed for the first time in the same browsing session.

3. The method of claim 1, further comprising
selecting an animation with movement to a given direction for pages that have been displayed before in the same browsing session and an animation with movement to the opposite direction for pages that are displayed for the first time in the same browsing session.

4. The method of claim 1, further comprising
selecting an animation with movement to a given direction if the command was a “Back”-command and an animation with movement to the opposite direction if the command was another load command.

5. The method of claim 1, wherein the animated icon is a rotating icon.

6. The method of claim 6, further comprising
selecting the direction of rotation differently for pages that have been displayed before in the same browsing session and for pages that are displayed for the first time in the same browsing session.

7. An electronic device, comprising:
a display;
means for browsing the Internet;
means for receiving a command from at least two different commands to load a page from the Internet into the display;
means for displaying an animated icon on the display while loading the page; and
means for selecting the animation on the basis of which the command was received.

8. The electronic device of claim 7, further comprising:
means for selecting a given animation if the received command is to load a page that has been displayed before in the same browsing session and
means for selecting a different animation if the command is to load a page that is displayed for the first time in the same browsing session.

9. The electronic device of claim 7, further comprising
means for selecting an animation with movement to a given direction for pages that have been displayed before in the same browsing session and an animation with movement to the opposite direction for pages that are displayed for the first time in the same browsing session.

10. The electronic device of claim 7, further comprising means for selecting a rotating icon as the animated icon.

11. The electronic device of claim 10, further comprising
means for selecting the direction of rotation differently for pages that have been displayed before in the same browsing session and for pages that are displayed for the first time in the same browsing session.

12. The electronic device of claim 10, further comprising
means for selecting an animation with movement to a given direction if the command is a “Back”-command and an animation with movement to the opposite direction if the command is another load command.

13. An electronic device, comprising:
a display;
a communication unit and a processor for browsing Internet;
a user interface for receiving a command from at least two different commands to load a page from Internet into the display;
the processor being configured to display an animated icon on the display while loading the page and to select the animation on the basis of which the command was received.

14. A computer program product encoding a computer program of instructions for executing a computer process for enhancing browsing in an electronic device, the process comprising:
receiving a command from at least two possible commands to load a page into the display of the electronic device;
displaying an animated icon on the display while loading the page;
selecting the animation on the basis of which the command was received.

15. A computer program distribution medium readable by a computer and encoding a computer program of instructions for executing a computer process for enhancing browsing in an electronic device, the process comprising:
receiving a command from at least two possible commands to load a page into a display of the electronic device;
displaying an animated icon on the display while loading the page;
selecting the animation the basis of the command.

16. The computer program distribution medium of claim 15, the distribution medium comprising a computer readable medium, a program storage medium, a record medium, a computer readable memory, a computer readable software distribution package, a computer readable signal, a computer readable telecommunications signal, and a computer readable compressed software package.
